(19) United States
(12) Patent Application Publication
(10) Pub. No.: US 2008/0267662 A1
(43) Pub. Date: Oct. 30, 2008

(54) LIGHT SCANNING DEVICE AND IMAGE FORMING APPARATUS

(76) Inventors: Nobuyuki Arai, Ebina-shi (JP); Yoshinori Hayashi, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/107,489

(22) Filed: Apr. 22, 2008

(30) Foreign Application Priority Data
Apr. 24, 2007 (JP) 2007-113670

(51) Int. Cl. G03G 15/04

(52) U.S. Cl. 399/177

(57) ABSTRACT

A light scanning device, which scans a surface to be scanned in a main scanning direction by a plurality of light beams, includes a light source including a plurality of light emitting parts that are arrayed two-dimensionally to emit the light beams, a separation optical system that separates a portion of the light beams emitted respectively from the plurality of light emitting parts, and a light receiving element that receives the portion of the light beams separated by the separation optical system. The separation optical system is a reduction system.

### PRIORITY CLAIM

This application claims priority from Japanese Patent Application No. 2007-113670, filed with the Japanese Patent Office on Apr. 24, 2007, the contents of which are incorporated herein by reference in their entirety.

### BACKGROUND OF THE INVENTION

1. Field of the Invention

The present invention relates to a light scanning device and an image forming apparatus, more specifically, to a light scanning device that scans a surface to be scanned by a plurality of light beams, and an image forming apparatus including the light scanning device.

2. Description of the Related Art

There is known an image forming apparatus that forms an image using Carlson's process, for example, a surface of a rotating photoconductive drum is scanned by light beams so that a latent image is formed on the surface of the rotating photoconductive drum. The image forming apparatus is configured to form an image by fixing a toner image obtained by visualizing the latent image to paper as a recording medium. In recent years, the image forming apparatus of this kind is often used in simplified printing as an on-demand printing system. Requests such as full coloring, higher-quality picture, higher speed, lower cost are increasing.

As a background of these, recently, an image forming apparatus with a plurality of light generating parts disposed two-dimensionally and monolithically and including a light source of for example, a surface light generating type laser array of vertical cavity surface emitting lasers (VCSELs) or the like is proposed to be able to simultaneously scan a plurality of scan lines on a surface to be scanned using the plurality of light beams projected from the light source.

The light source described above using the surface light generating type laser array or the like of the VCSELs and so on, differs from an edge-emitting type laser in that it does not generate rearward projection light so that, for example, as described in JP8-330661A, JP2003-215485A and JP2002-26445A, by splitting a portion of light beams scanning a surface to be scanned using a beam splitter, a half mirror and a triangular prism, thereby driving the light source while monitoring the split light beams, optical quantity control of light beams that scan the surface to be scanned (referred to as scanning light hereinbelow) is performed.

However, an output from VCSEL is approximately 1˜2 mW and is low in comparison to an edge-emitting type laser or the like. By splitting a portion of the scanning light by an above-described beam splitter or the like, it is problematic in that loss is generated in light quantity of light beams essentially necessary for scanning. Furthermore, the scanning light, when passing the beam splitter, receives the influence of surface precision of a reflecting surface or a deflected surface of the beam splitter so that positional variation is generated on a beam spot of the scanning light, and it is problematic in that optical property deteriorates.

In addition, the light generating part of VCSEL is disposed two-dimensionally so that in order to monitor light quantity of the plurality of light beams, it is necessary to use a light receiving element having a large enough light receiving surface to some extent. However, if the light receiving surface becomes large, the responsiveness of the light receiving element deteriorates, furthermore, it is problematic that the device becomes larger and requires higher cost.

### SUMMARY OF THE INVENTION

An object of the present invention is to provide a light scanning device that is smaller and has lower cost and be able to seek improvement in light beam use efficiency.

To accomplish the above object, a light scanning device according to one embodiment of the present invention is configured to scan a surface to be scanned in a main scanning direction by a plurality of light beams. The light scanning device includes a light source including a plurality of light emitting parts that are arrayed two-dimensionally to emit the light beams, a separation optical system that separates a portion of the light beams emitted respectively from the plurality of light emitting parts, and a light receiving element that receives the portion of the light beams separated by the separation optical system. The separation optical system is a reduction system.

### BRIEF DESCRIPTION OF THE DRAWINGS

FIG. 1 is a diagram illustrating an approximate constitution of an image forming apparatus according to an embodiment of the present invention.

FIG. 2 is a perspective view illustrating an approximate constitution of a light scanning device.

FIG. 3 is a schematic diagram illustrating a photonic device or the like disposed in the vicinity of a light source.

FIG. 4 is a diagram illustrating the light source.

FIG. 5 is a first diagram describing a position to dispose an aperture member.

FIG. 6A and FIG. 6B are second and third diagrams describing positions to dispose the aperture member.

FIG. 7 is a diagram describing a modified example 1 of a monitoring optical system.

FIG. 8 is a diagram describing a modified example 2 of the monitoring optical system.

FIG. 9 is a diagram describing a modified example 3 of the monitoring optical system.

FIG. 10 is a diagram illustrating an approximate constitution of an image forming apparatus corresponding to color images.

### DETAILED DESCRIPTION OF THE PREFERRED EMBODIMENTS

Preferred embodiments of the present invention will be explained in detail hereinafter with reference to the accompanying drawings.

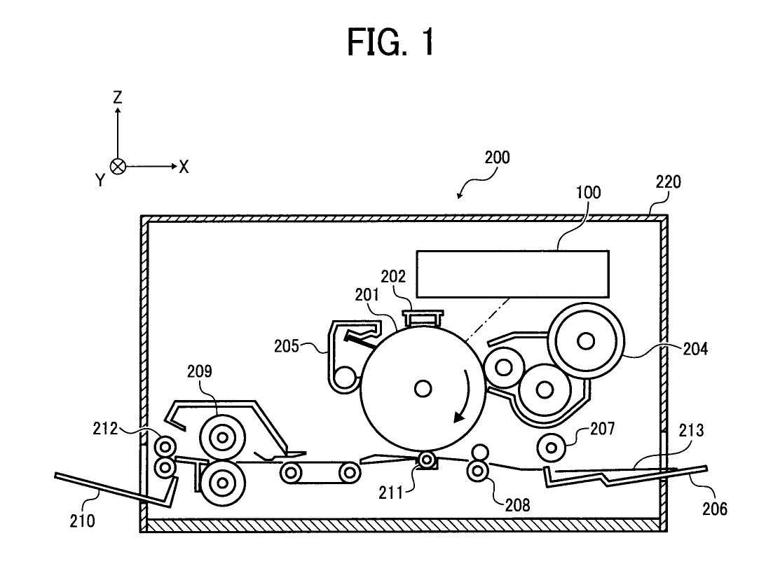

A schematic structure of an image forming apparatus 200 according to one embodiment of the present invention is illustrated in FIG. 1.

The image forming apparatus 200 is a printer that prints images by transferring a toner image to a standard paper (sheet) using Carlson's process. The image forming apparatus 200, as illustrated in FIG. 1, includes a light scanning device 100, a photoconductive drum 201, an electrostatical charger 202, a toner cartridge 204, a cleaning case 205, a paper feeding tray 206, a paper feeding roller 207, a pair of resist rollers 208, a transfer charger 211, a fixing roller 209, a paper discharging roller 212, a paper discharging tray 210 and a housing 220 that holds the above parts.

The housing 220 is in an approximately rectangular solid shape and has an opening that connects with the interior space in side walls of +X side and −X side.

The light scanning device 100 is disposed in an upside of an interior portion of the housing 220. The surface of the photoconductive drum 201 is scanned in a main scanning direction (the Y axis direction of FIG. 1) with light beams modulated based on image information. The constitution of the light scanning device 100 is described later.

The photoconductive drum 201 is a cylindrical-shaped member having a surface on which a photosensitive layer is formed. When light beams are emitted to the photosensitive layer of the photoconductive drum 201, the area to which the light beams are emitted becomes electrically conductive. The photoconductive drum 201 is disposed on the lower side of the light scanning device 100 so as to have a longitudinal direction corresponding to the Y axis direction and rotated clock-wisely in FIG. 1 (the direction indicated by an arrow in FIG. 1) by a not-illustrated rotating mechanism. Around the photoconductive drum 201, the electrostatical charger 202 is disposed in a 12 o'clock position (upside) of FIG. 1, the toner cartridge 204 is disposed in a 2 o'clock position, the transfer charger 211 is disposed in a 6 o'clock position and the cleaning case 205 is disposed in a 10 o'clock position.

The electrostatical charger 202 is disposed via a prescribed clearance against the surface of the photoconductive drum 201 and electrostatically charges the surface of the photoconductive drum 201 by a prescribed voltage.

The toner cartridge 204 includes a cartridge main body filled with a toner of a black image component, an image development roller electrostatically charged with voltages of a reverse polarity from the photoconductive drum 201 and so on. The toner cartridge 204 supplies toner filled in the cartridge main body to the surface of the photoconductive drum 201 via the image development roller.

The cleaning case 205 includes a rectangular-shaped cleaning blade having a longitudinal direction corresponding to the Y axis direction and is disposed such that an edge of the cleaning blade is in contact with the surface of the photoconductive drum 201. The toners absorbed to the surface of the photoconductive drum 201 are peeled off by the cleaning blade accompanying the rotation of the photoconductive drum 201 and recollected in an internal part of the cleaning case 205.

The transfer charger 211 is disposed via a prescribed clearance against the surface of the photoconductive drum 201 and voltages of a reverse polarity from the electrostatical charger 202 are applied to the transfer charger 211.

The paper feeding tray 206 is disposed in a state where an edge of the +X side extends from an opening formed on the side walls of the +X side of the housing 220 to hold a plurality of paper sheets 213 fed through an external part.

The paper feeding roller 207 takes out the paper sheets 213 sheet by sheet from the paper feeding tray 206 and leads to a gap formed between the photoconductive drum 201 and the transfer charger 211 via the resist roller pair 208 constituted by a pair of rotating rollers.

The fixing roller 209 is constituted by a pair of rotating rollers. The fixing roller 209 lets the paper sheets 213 go through heating and be pressurized and then leads the paper sheets 213 to the paper discharging roller 212.

The paper discharging roller 212 is constituted by a pair of rotating rollers or the like and sequentially stacks the paper sheets 213 sent from the fixing roller 209 against the paper discharging tray 210 disposed in a state where the edge of the −X side extends from the opening formed on the side walls of the −X side of the housing 220.

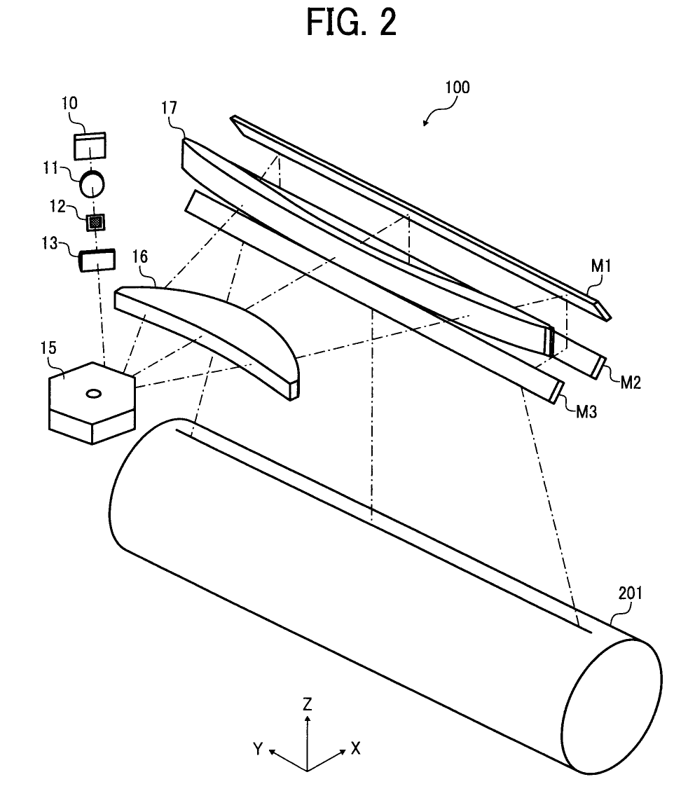

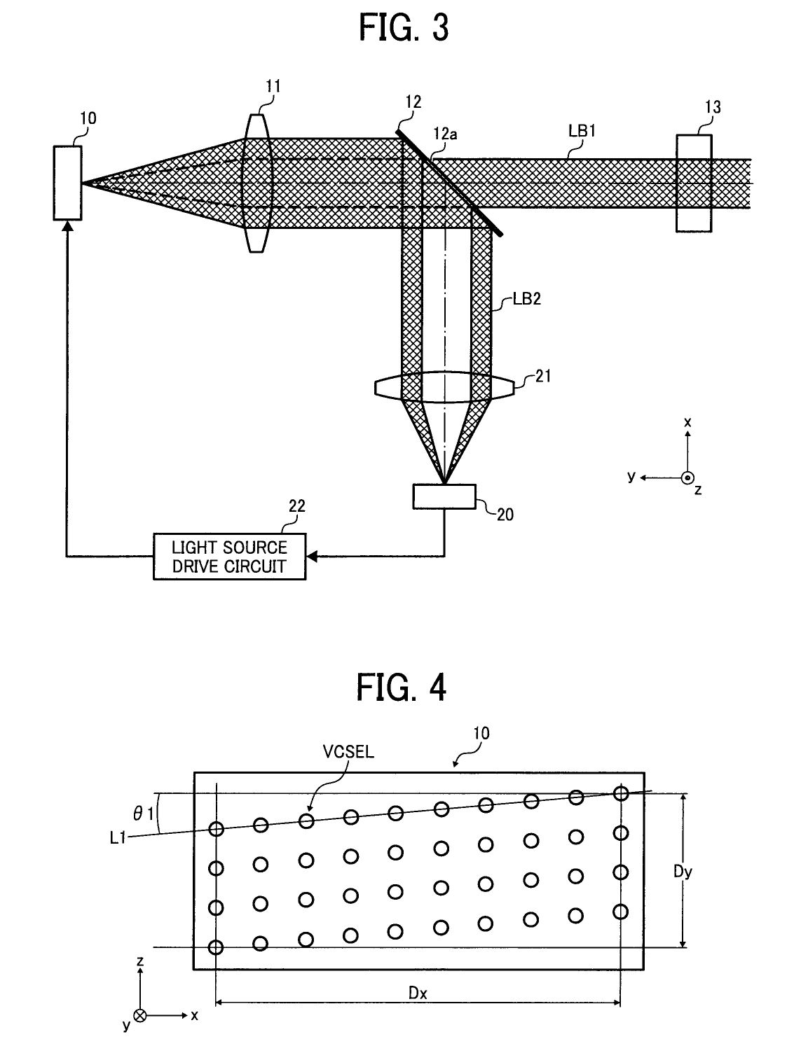

Next, the constitution of the light scanning device 100 is described. FIG. 2 is a figure that illustrates the light scanning device 100 together with the photoconductive drum 201. FIG. 3 is a figure that schematically illustrates an optical element or the like disposed in the vicinity of the light source 10. As is clear considering FIG. 2 and FIG. 3 in a comprehensive manner, the light scanning device 100 is constituted by including a light source 10 that projects the plurality of light beams, a coupling lens 11 disposed along a straight line which forms an approximately 59 degree angle with the X axis with the light source 10 as the base point, an aperture member 12, a line image forming lens 13, a polygon mirror 15, first and second scanning lenses 16, 17 and three folding back mirrors M1, M2, M3, which are sequentially disposed on the +X side of the polygon mirror 15, a condensing lens 21, a light receiving element 20 and a light source drive circuit 22 that drives the light source 10 and so on, which are sequentially disposed in the −X side of the aperture member 12. Hereby for convenience of description, an xyz coordinate system is defined by rotating approximately 30 degrees the XY coordinates about the Z axis as the center. Descriptions using the coordinate system are utilized accordingly hereinbelow.

The light source 10 as a light generating point is, for example, a surface light generating type semiconductor laser array in which VCSELs are disposed two-dimensionally. As shown in FIG. 4, on a light generating surface (a surface of the −y side), 40 VCSELs are disposed in a matrix of 4 rows and 10 columns with a row direction parallel to a straight line L1 which forms an angle θ1 with the Y axis and a column direction parallel to the Z axis.

Dx is an interval in the main scanning direction between two VCSELs of the light source having a largest distance from each other in the main scanning direction, and Dy is an interval in the sub scanning direction between two VCSELs of the light source having a largest distance from each other in the sub scanning direction. As one example of the present embodiment, the most distant interval Dx between two VCSELs in the main scanning direction is 300 μm, the most distant interval Dy between two VCSELs in the sub-scanning direction is 100 μm. In addition, the output of each VCSEL is approximately 2.5 mW, and an oxidization stenosis system of the VCSELs is formed in an approximately square shape of one side of approximately 4 μm. Light beams with a divergence angle of 9 degrees are projected from the respective VCSELs.

The coupling lens 11 is an optical element made of resin in which a first surface facing the light source 10 is a diffractive surface of a rotational symmetry shape. In the present embodiment, the focusing length f1 of the coupling lens 11 is 45 mm, and the diameter of an effective area of the coupling lens 11 is 7 mm. The light beams projected from the light source 10 (diverging light) are turned into approximately parallel light by fairing after transmitting through the coupling lens 11.

The aperture member 12 is a member in a plate-like form, in the center of which, as one example, an opening 12a in a rectangular shape with a width of 5.2 mm in a Y axis direction (main scanning direction) and a width of 2.1 mm in a Z axis direction (sub-scanning direction) is formed. A surface of the aperture member 12, to which light beams transmit through the coupling lens 11 is incident, is a reflecting surface formed by, for example, making aluminum or the like be vapor-deposited. The center of the opening 12a of the aperture member 12 is positioned in a focal point position of the coupling lens 11 or the vicinity of the focal point position. As shown in FIG. 3, the aperture member 12 is disposed in a state where the reflecting surface is tilted approximately 45 degrees in relation to the light axis of the coupling lens 11. In addition, the reasons why the center of the opening 12a of the aperture member 12 is disposed in the focal point position of the coupling lens 11 or the vicinity of the focal point position are as follows.

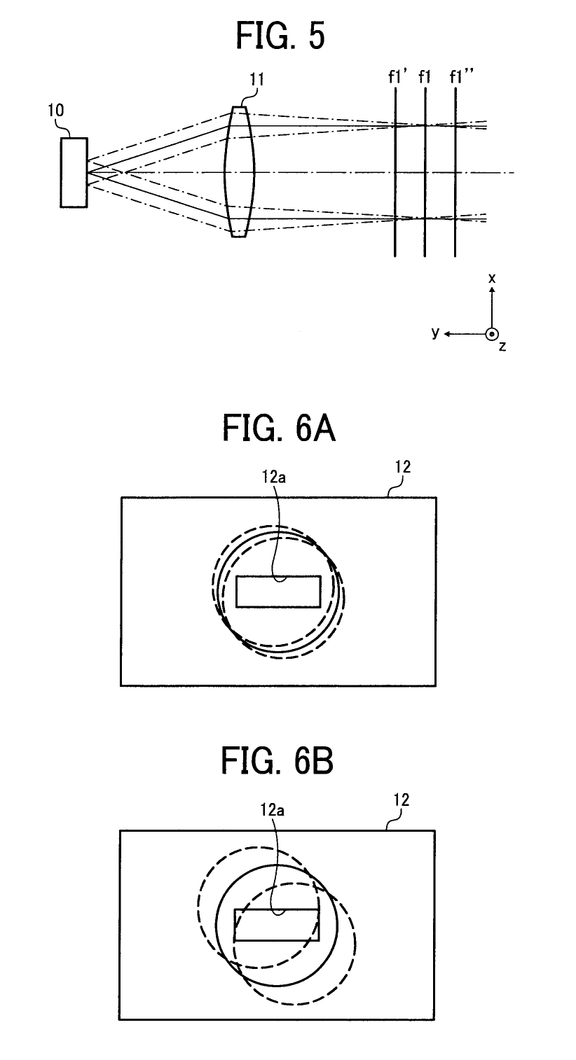

In the case where the VCSELs are provided two-dimensionally on the light source 10 as described above, as shown in FIG. 5, the light beams projected from each VCSEL are once converged in the vicinity of the focal point position f1 of the coupling lens 11. Therefore, by disposing the opening 12a of the aperture member 12 in the focal point position of the coupling lens 11 or a position in the vicinity of the focal point position, as shown in FIG. 6A, the opening 12a becomes included in imaging surfaces of all light beams so that the shapes of all light beams can be uniformly given fairing. However, as shown, for example, in FIG. 5, in the case where the opening 12a of the aperture member 12 is disposed in the position of f1′ or f1″ which to a certain extent deviates from the focal point position f, as shown in FIG. 6B, there are cases where the opening 12a projects out from the imaging surfaces of whichever of the light beams so that it is difficult to uniformly give fairing of beam shapes of all light beams. Therefore, the center of the opening 12a of the aperture member 12 is desirably disposed in the focal point position of the coupling lens 11 or a position in the vicinity of the focal point position.

The line image forming lens 13 is a cylindrical lens in which the surface facing the polygon mirror 15 has refractive power in the Z axis direction (sub-scanning direction), and the line image forming lens 13 collects light beams passing through the aperture member 12 to a deflected surface of the polygon mirror 15. In the present embodiment, a rear side focusing length of the line image forming lens 13 is 125 mm.

The polygon mirror 15 is a polygonal column member in which a top surface and an under surface are regular hexagons. Six deflected surfaces are formed in a side surface of the polygon mirror 15, rotated at a constant angular speed and spun around an axis parallel to the Z axis by a not-illustrated rotating mechanism. Herewith light beams incident to the polygon mirror 15 are scanned in the Y axis direction.

The first scanning lens 16 and the second scanning lens 17 are respectively in coordination and form an image on the photoconductive drum 201 via folding back mirrors M1 through M3, using light beams reflected by the deflected surface of the polygon mirror 15. In the present embodiment, the first scanning lens 16 and the second scanning lens 17 have a center thickness of 3 mm and the distances from the center of the polygon mirror 15 to an incidence plane are respectively 43.2 mm and 101.3 mm.

The condensing lens 21 is made of resin materials or the like and is, for example, a spherical surface lens of a rotational symmetry of a focusing length f2 of 36 mm. The condensing lens 21 collects light beams reflected in the −X direction by the aperture member 12 to a light receiving surface of the light receiving element 20.

The light receiving element 20 is a photo diode having a light receiving surface of a dimension of 240 μm in the main scanning direction and of 80 μm in the sub-scanning direction dimension. The light receiving element 20 is disposed such that it is optically conjugated with the light source 10. When light beams enter the light receiving surface, the light receiving element 20 outputs signals in correspondence to the intensity of light beams (photoelectric conversion signal).

The light source drive circuit 22 monitors the signals outputted from the light receiving element 20 and drives the light source 10 such that light beams outputted from each VCSEL of the light source 10 become desired values.

In the light scanning device 100 constituted as described above, an optical system including the condensing lens 21 and the coupling lens 11 disposed on the light path of light beams between the light source 10 and the light receiving element 20, is defined as a monitoring optical system hereinbelow. A lateral magnification of the monitoring optical system is expressed by f2/f1 (focusing length of the condensing lens 21/focusing length of the coupling lens 11) and the lateral magnification is 0.8 (=36/45). In addition, in the light scanning device 100, a half angle of view is ±34.8 degrees in relation to an image height of ±150 mm of the surface of the photoconductive drum 201, and is ±37.4 degrees in relation to an image height of ±162 mm. The lateral magnifications from the light source 10 to the surface of the photoconductive drum 201 are 4.9 times in the main scanning direction and 2.3 times in the sub-scanning direction.

Next, the movement of the image forming apparatus 200 constituted as above is described. When image information from a superordinate device is received, the light scanning device 100 is driven by modulation data based on the image information and 40 light beams modulated based on the image information are projected from the light source 10. The light beams, as shown in FIG. 3, are respectively given fairing into approximately parallel light by transmitting through the coupling lens 11 and then are incident to the aperture member 12 to be separated into a light beam LB1 for scan use, which passes the opening 12a and a light beam LB2 for monitoring use, which is reflected in the −X direction by a reflective surface formed in the peripheral part of the opening 12a.

Within the separated light beams, the light beam LB1 for scan use is incident to a deflected surface of the polygon mirror 15 via the line image forming lens 13 and is scanned in the Y axis direction by being deflected by the deflected surface of the polygon mirror 15. Thereafter, the light beam LB1 for scan use, when in a state where the scan speed is adjusted by the first scanning lens 16, is collected to the surface of the photoconductive drum 201 via folding back mirrors M1 through M3 by the second scanning lens 17.

In addition, within the separated light beams, the light beam LB2 for monitoring use is incident to the light receiving element 20 by the condensing lens 21. The light source drive circuit 22 constantly monitors the signals outputted when the light beam LB2 for monitoring use is incident to the light receiving element 20 and optical quantity control of the light beams outputted from the light source 10 is performed.

Specifically, after the light beam for scan use is deflected by the deflected surface of the polygon mirror 15, in the interval before reaching the writing area of the photoconductive drum 201, the intensity of light beams projected from the light source 10 is detected based on signals obtained when the light beam LB2 for monitoring use is incident to the light receiving element 20. The value of the injected power that supplies each VCSEL is set (determined) so that the intensity of light beams projected from the light source 10 becomes the preliminarily set intensity. Herewith the light beam LB1 for scan use from each VCSEL is incident to a surface to be scanned of the photoconductive drum 201 in a state where the intensity of the light beam LB1 is adjusted to the preliminarily set intensity. In addition, the value of the injected power described above is retained until the scanning of the writing area is finished and is set again before the next scanning of the writing area. That is, every time the writing area is scanned, an output adjustment of each VCSEL is performed. The setting of the injected power that supplies each VCSEL, is not necessarily performed for all VCSELs in every scanning, but, for example, the setting of the injected power can be performed for one VCSEL at a time in every scanning.

On the other hand, a photosensitive layer on the surface of the photoconductive drum 201 is charged with a prescribed voltage by the electrostatical charger 202 so that electrical charges are distributed by a certain amount of electrical charge density. When the photoconductive drum 201 is scanned by light beams deflected by the polygon mirror 15, the photosensitive layer where the light beams are collected begins to have an electrically conductive property and electrical potential of the electrically conductive part of the photosensitive layer becomes zero. Therefore, the photoconductive drum 201 rotating in the direction of an arrow in FIG. 1 is scanned by the light beams modulated based on image information so that an electrostatic latent image prescribed by a distribution of electrical charges is formed on the surface of the photoconductive drum 201.

When the electrostatic latent image is formed on the surface of the photoconductive drum 201, by an image development roller of a toner cartridge 203, toner is supplied to the surface of the photoconductive drum 201. Herewith the image development roller of the toner cartridge 203 is electrically charged by voltages of a reverse polarity as the photoconductive drum 201 so that the toner adherent to the image development roller is electrically charged with the same polarity as the photoconductive drum 201. Therefore, the toner is not adhered to the part on the surface of the photoconductive drum 201, where electrical charges are distributed, but only adhered to the scanned part so that a toner image obtained by visualizing the electrostatic latent image is formed on the surface of the photoconductive drum 201. This toner image is adhered to the paper sheet 213 by the transfer charger, and then fixed by the fixing roller 209 so that an image is formed on the paper sheet 213. In such a way, the paper sheet 213 where the image is formed, is discharged by the paper discharging roller 212 and sequentially stacked to the paper discharging tray 210.

As described above, in the light scanning device 100 according to the present embodiment, the monitoring optical system including the aperture member 12, the condensing lens 21 and the coupling lens 11 disposed on the optical path of light beams between the light source 10 and the light receiving element 20 is a reduction system including the coupling lens 11 and the condensing lens 21. Therefore, it is possible to reduce the size of the light receiving element 20.

Specifically, as shown in FIG. 3, when the most distant interval between VCSELs in the main scanning direction of the light source 10 is Dx, the most distant interval between VCSELs in the sub-scanning direction is Dy, the lateral magnification in the main scanning direction of the monitoring optical system is βx, and the lateral magnification in the sub-scanning direction is βy, in the main scanning direction, the dimension of a light receiving surface of the light receiving element 20 necessary for light receiving of all light beams projected from the light source 10 is represented by Dx βx, and the dimension thereof in the sub-scanning direction is represented by Dy·βy. In the case that the monitoring optical system is a reduction system, the lateral magnification βx in the main scanning direction and the lateral magnification βy in the sub-scanning direction both become smaller than 1 so that the dimension Dx·βx in the main scanning direction of the acceptance surface of the light receiving element 20 and the dimension Dy·βy in the sub-scanning direction can become smaller than the dimension Dx in the main scanning direction and the dimension Dy in the sub-scanning direction of a light generating area where VCSELs of the light source 10 are disposed. Therefore, it is possible to improve the light scanning device 100 to be made a smaller size and at lower cost. Also, by reducing the area of the light receiving surface of the light receiving element 20, it is possible to improve the responsiveness of the light receiving element 20. The light generating area hereby includes all VCSELs formed in the light source 10 and is a rectangular-shaped region with the dimension Dx in the main scanning direction and the dimension Dy in the sub-scanning direction where the area is the smallest.

Also, in the present embodiment, the coupling lens 11 and the condensing lens 21 are anamorphic lenses in a rotational symmetry spherical surface shape and therefore have the lateral magnification βx in the main scanning direction and the lateral magnification βy in the sub-scanning direction of the monitoring optical system which are equal to each other. Therefore, by making a light receiving surface shape of the light receiving element 20 to a similar shape to the light generating area of the light source 10, the light receiving surface can further become smaller and as a result, the light scanning device 100 can be made a smaller size and at lower cost.

Specifically, it is sufficient that the shape of the light receiving surface of the light receiving element be in a similar shape to the shape of the light generating area of the light source. The size of the shape of the light receiving surface of the light receiving element is obtained by multiplying the dimensions in the main scanning direction and sub-scanning direction of the light generating area with the magnification ratio of the monitoring optical system, which gives a dimension of 240 μm (=300×0.8) in the main scanning direction and a dimension of 80 μm (=100×0.8) so that the separated light beam LB2 for monitoring use can all be received. In addition, for example, when the coupling lens and the condensing lens having the focusing lengths of 50 mm and 80 mm, respectively is used, the dimensions in the main scanning direction and sub-scanning direction need to be respectively set to 480 μm and 160 μm and therefore a light receiving element that is 4 times the size of the light receiving element 20 is necessary.

In addition, in the present embodiment, the light source 10 and the light receiving element 20 are disposed such that the positional relationship therebetween is optically approximately conjugated. Consequently, it is possible to reduce the accidental error in installing the light source 10 and the light receiving element 20 or the dispersion of light quantity of light beams because of positional relationship change or the like due to temperature fluctuation. For example, because of an installing error or the like, when the light source 10 jolts out of alignment in a direction rotating around the light axis, the light path of the light beams minutely jolts out of alignment. If the size of the light receiving surface of the light receiving element 20 is set to a minimum at the moment, the light quantity of light beams incident to the light receiving element generates dispersion by misalignment of the light path. Herewith since appropriate light quantity detection is not performed in the light receiving element 20, it is possible that negative influences such as concentration surface irregularity or the like appear in the output image. On the other hand, if the light receiving surface of the light receiving element 20 is enlarged by only the margin portion given consideration to light path misalignment or the like, the growth in size, the requirement of higher cost and the degradation in responsiveness occur in the device. Thereby, by setting the optical positional relationship between the light source 10 and the light receiving element 20 to be approximately conjugated, the positions of light beams incident to the light receiving element can be maintained virtually constant. In addition, concomitantly to this, an adjustment mechanism can be provided to the aperture member 12 or the like.

In addition, of the light beams projected from each VCSEL of the light source 10, the light beams projected in the −Y direction including main light rays passes through the aperture member 12 and the rest of the light beams are reflected to perform separation of the light beams from the light source 10. Herewith light beams of higher strength including the main light rays from each VCSEL are used to scan the photoconductive drum 201 and based on light beams that originally do not contribute to scan, the intensity of the light beams from the light source 10 is monitored so that it is possible to improve the light use efficiency of light beams. Because the peripheral parts of light beams projected from each VCSEL are used as light beams for monitoring use, a beam spot aspect of the acceptance surface of the light receiving element 20 degrades, but the light beams for monitoring use do not require the beam spot aspect for the light beams for scan use and it is sufficient for the light beams for monitoring use to have a quality of being able to monitor light quantity.

In addition, the aperture member 12 has a function to perform separation of light beams and a function to give fairing to a beam shape of the passing light beams. Other than the aperture member, in comparison to the case in which a separation element of an alternative beam splitter or the like is disposed, the aperture member 12 can reduce the number of parts to be used so that a smaller and lower cost device becomes possible.

### MODIFIED EXAMPLE 1

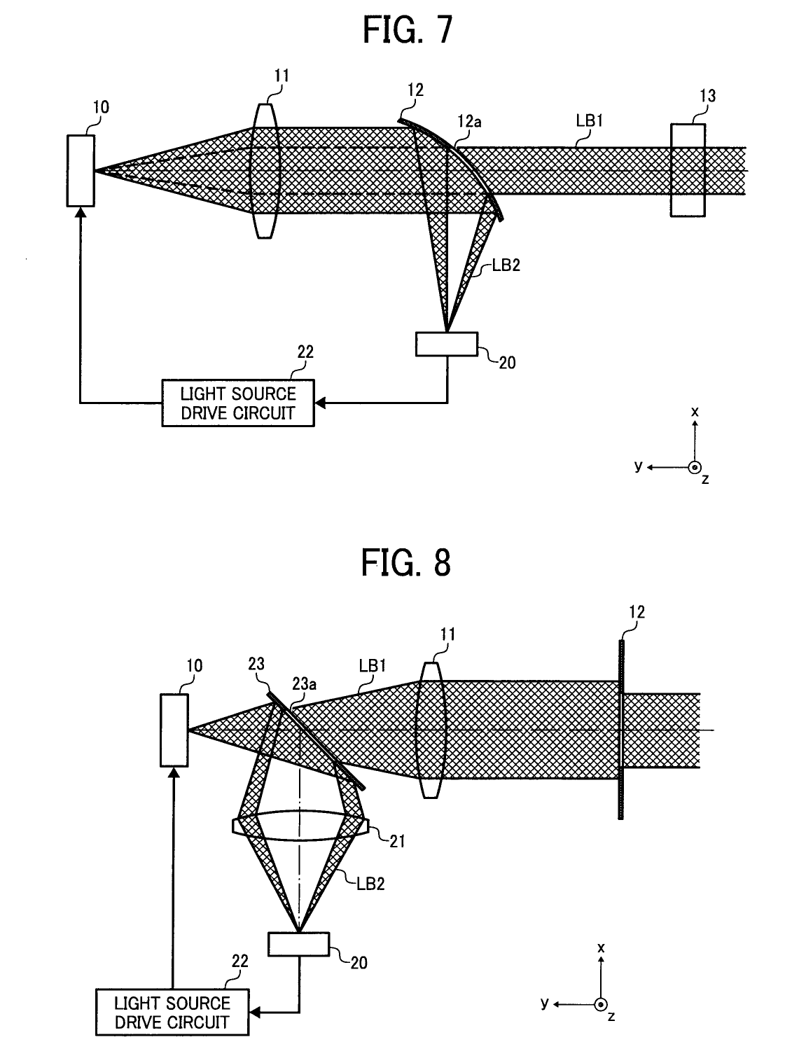

In addition, although in the present embodiment, the aperture member 12 having a flat reflective surface to reflect light beams for monitoring use is described, the present invention is not limited thereto. As shown in FIG. 7, the aperture member 12 can have a curved surface having a focal point. In such a case, the light receiving element 20 is disposed such that the light receiving surface of the light receiving element 20 is situated in a focal point position of the reflective surface or the vicinity thereof. Thereby it is no longer necessary to dispose the condensing lens 21 and lessening the number of parts become possible. In addition, by enlarging the degree of curvature of the curved reflective surface to collect light beams in the vicinity of the aperture member 12, the optical path from the light source 10 to the light receiving element 20 can be shortened so that it is possible for the light scanning device to become smaller. In a modified example 1, the reflective surface of the aperture member 12 is a concave mirror with a curvature diameter of 72 mm. The acceptance surface of the light receiving element 20 is disposed in a position about 36 mm away from the center of the aperture member 12 so that a monitoring optical system with a lateral magnification of about 0.8 is constituted.

### MODIFIED EXAMPLE 2

In addition, as shown in FIG. 8, a separation optical element 23 that separates a portion of the light beams is disposed on the optical path between the light source 10 and the coupling lens 11, and the light beam LB2 for monitoring use separated by the separation optical element 23 can be received by the light receiving element 20. The separation optical element 23, likewise to the above-described aperture member 12, is a member in a plate form with an opening 23a formed in the center. The surface on the side where light beams transmitting through the coupling lens 11 are incident is a reflective surface formed by having, for example, aluminum or the like vapor deposited.

As described above, by disposing the separation optical element 23 between the light source 10 and the coupling lens 11, the degree of freedom of layout of the coupling lens 11 and the following components of the optical system increases and it is possible for the monitoring optical system to be small-sized. In a modified example 2, the focusing length of the condensing lens 21 is 20 mm, and by setting the optical path length from the light source to the condensing lens 21 to 45 mm, and the optical path length from the condensing lens 21 to the light receiving surface of the light receiving element 20 to 36 mm, a monitoring optical system of a lateral magnification of about 0.8 is constituted.

### MODIFIED EXAMPLE 3

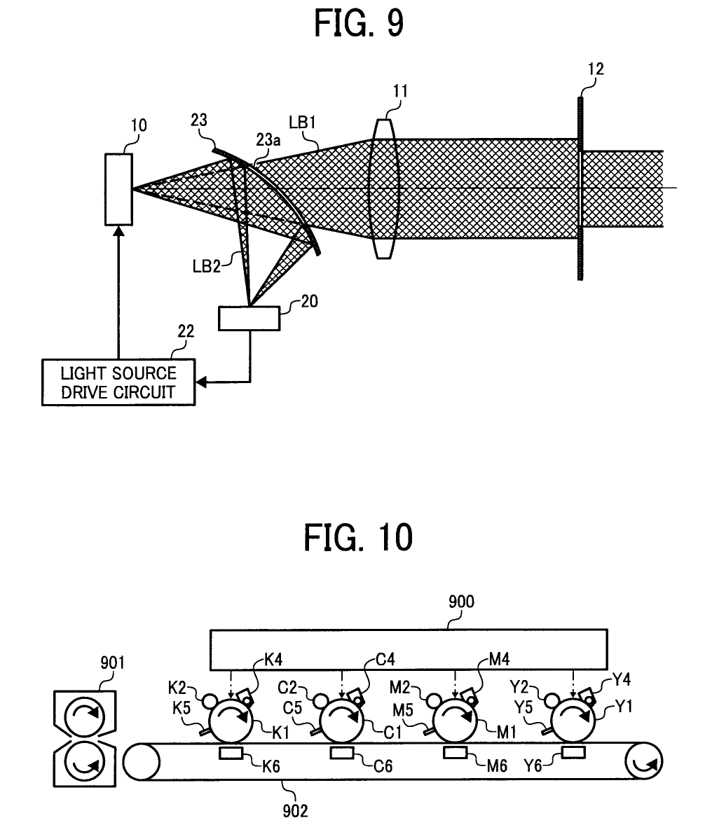

In addition, in the case of disposing the separation optical element 23 that separates a portion of the light beams on the optical path between the light source 10 and the coupling lens 11, as shown in FIG. 9, the reflective surface of the separation optical element 23 can be a curved surface having a focal point. In such a case, the light receiving element 20 is disposed such that the light receiving surface of the light receiving element 20 is situated in a focal point position of the reflective surface or the vicinity thereof. Thereby it is no longer necessary to dispose the condensing lens 21 and lessening the number of parts becomes possible. In addition, by enlarging the degree of curvature of the curved reflective surface to collect light beams in the vicinity of the separation optical element 23, the optical path from the light source 10 to the light receiving element 20 can be shortened so that it is possible for the light scanning device to become smaller. In a modified example 3, the reflective surface of the separation optical element 23 is a concave mirror with a curvature diameter of 24 mm. The separation optical element 23 is disposed in a position 27 mm away from the light source. The light receiving surface of the light receiving element 20 is disposed in a position about 21.6 mm away from the center of the separation optical system 23 so that a monitoring optical system with a lateral magnification of about 0.8 is constituted.

In addition, the image forming apparatus 200 according to the present embodiment includes the light scanning device 100. Therefore, a device of smaller size is realized and a final image is formed based on the latent image formed by the light scanning device 100 of which light use efficiency is improved. Therefore, it is possible to form an image with high precision on the recording media (paper 213).

In addition, in the above embodiment, described is a case in which the light scanning device 100 is used as a single color image forming apparatus (printer). But the image forming apparatus, as one example shown in FIG. 10, can correspond to a color image and be a tandem color device including a plurality of photoconductive drums. The tandem color device shown in FIG. 10 includes a photoconductive drum K1 for black (K), a charger K2, an image development device K4, a cleaning device K5 and a charge device K6 for transfer, a photoconductive drum C1 for cyan (C), a charger C2, an image development device C4, a cleaning device C5 and a charge device C6 for transfer, a photoconductive drum M1 for magenta (M), a charger M2, an image development device M4, a cleaning device M5 and a charge device M6 for transfer, a photoconductive drum Y1 for yellow (Y), a charger Y2, an image development device Y4, a cleaning device Y5 and a charge device Y6 for transfer, a light scanning device 900, a transfer belt 901 and a fixing device 902 and so on.

In this case, in the light scanning device 900, for example, the plurality of light generating parts of the light source 10 are divided into for black, for cyan, for magenta and for yellow. Then light beams from each light generating part for black are irradiated onto the photoconductive drum K1, light beams from each light generating part for cyanide are irradiated onto the photoconductive drum C1, light beams from each light generating part for magenta are irradiated onto the photoconductive drum M1 and light beams from each light generating part for yellow are irradiated onto the photoconductive drum Y1. The same as the light scanning device 100, a portion of the light beams from the light source are received by a light receiving element via a monitoring optical system which is a reduction system. An output from the light source 10 is adjusted based on a photoelectric conversion signal outputted from the light receiving element. In addition, the light scanning device 900 can include the individual light source 10 on a color to color basis. And each color may include the light scanning device 900.

Each photoconductive drum rotates in the direction of an arrow in FIG. 10, and a charger, an image development device, a charge device for transfer and a cleaning device are disposed in the sequence of rotation. Each charger uniformly charges the surface of the corresponding photoconductive drum. Beams are irradiated by the light scanning device 900 to the surface of the photoconductive drum charged by the charger so that an electrostatic latent image is formed on the photoconductive drum. Then a toner image is formed on the surface of the photoconductive drum by a corresponding image development device. Furthermore, by a corresponding charge device for transfer, the toner images of each color are transferred to recording paper and finally an image is fixed to the recording paper by a fixing device 30.

In addition, in each embodiment described above, although the case where the light scanning device 100 of the present invention is used for a printer is described, the light scanning device 100 may also be suited for image forming apparatuses other than the printer, for example, a copier machine, a facsimile or a hybrid machine putting these together.

According to one aspect of the present invention, the separation optical system, which leads light beams to the light receiving element by separating a portion of light beams projected from each light generating part of the light source, becomes a reduction system. Herewith, it is possible to let a light receiving surface of a light receiving element be smaller than a light generating region in which the light generating part of the light source is disposed so that it is possible to provide a smaller and lower cost device. In addition, by letting the light receiving surface of the light receiving element become smaller, it is possible to improve the responsiveness of the light receiving element and consequently, it is possible to promote improvement in use efficiency of the light beams.

According to another aspect of the present invention, there is provided an image forming apparatus that forms an image by fixing to a recording media a toner image formed based on a latent image obtained from information with regard to an image. The image forming apparatus includes a light scanning device of the present invention; a photoreceptor in which a latent image is formed by the light scanning device; an image development device that visualizes the latent image formed in the surface to be scanned of the photoreceptor; a transfer device that fixes to the recording media the toner image visualized by the image development device.

Accordingly, by the light scanning device in which improvement in light use efficiency is attempted, a latent image is formed on a photoreceptor. Then the latent image is visualized and transferred to a recording media so that a final image is formed. Therefore, it is possible to form an image with high precision on the recording media.

According to still another aspect of the present invention, a toner image formed based on a latent image of each color obtained from information with regard to a multi-color image is fixed superimposed with a recording media so that the image forming apparatus forms a multi-color image. The image forming apparatus includes a light scanning device of the present invention; a plurality of photoreceptors in which latent images corresponding to each color are formed respectively by the light scanning device; an image development device that visualizes latent images formed respectively on surfaces to be scanned of the plurality of photoreceptors; a transfer device that fixes the toner image of each color visualized by the image development device by superimposing the toner image with the recording media.

Accordingly, by the light scanning device in which improvement in light use efficiency is attempted, latent images are formed on respective photoreceptors. Then the latent images are visualized and transferred superimposed with the recording media so that final multi-color images are formed. Therefore, it is possible to form a multi-color image with high precision on the recording media.

Although the preferred embodiments of the present invention have been described, it should be understood that the present invention is not limited to these embodiments, various changes and modifications can be made to the embodiments.

What is claimed is:

1. A light scanning device that scans a surface to be scanned in a main scanning direction by a plurality of light beams, comprising:
a light source including a plurality of light emitting parts that are arrayed two-dimensionally to emit the light beams;
a separation optical system that separates a portion of the light beams emitted respectively from the plurality of light emitting parts; and
a light receiving element that receives the portion of the light beams separated by the separation optical system,
the separation optical system being a reduction system.

2. A light scanning device according to claim 1, wherein a positional relationship between the light source and the light receiving element is optically approximately conjugate.

3. A light scanning device according to claim 1, wherein
in a case where an interval in the main scanning direction between two light generating parts of the light source having a largest distance from each other in the main scanning direction is larger than an interval in the sub scanning direction between two light generating parts of the light source having a largest distance from each other in the sub scanning direction, a dimension of a light receiving surface of the light receiving element in the main scanning direction is larger than a dimension of the light receiving surface in the sub scanning direction; and
in a case where the sub scanning direction interval is larger than the main scanning direction interval, the dimension of the light receiving surface in the sub scanning direction is larger than the dimension of the light receiving surface in the main scanning direction.

4. A light scanning device according to claim 1, wherein a ratio of an interval in the main scanning direction between two light generating parts of the light source having a largest distance from each other in the main scanning direction to an interval an interval in the sub scanning direction between two light generating parts of the light source having a largest distance from each other in the sub scanning direction is approximately equal to a ratio of a dimension of a light receiving surface of the light receiving element in the main scanning direction to a dimension of the light receiving surface in the sub-scanning direction.

5. A light scanning device according to claim 1, wherein the separation optical system includes a separation optical element having a reflective surface which reflects the portion of the light beams emitted respectively from the plurality of light generating parts.

6. A light scanning device according to claim 5, wherein the reflective surface of the separation optical element is a reflective surface having a positive power to the light beams.

7. A light scanning device according to claim 5, wherein the separation optical element has an opening shaping light beams imaged on the surface to be scanned of the light beams emitted respectively from the plurality of light generating parts.

8. A light scanning device according to claim 5,
further comprising a coupling element that couples the plurality of light beams,
wherein the separation optical element is disposed on an optical path of the light beams between the coupling element and the light source.

9. A light scanning device according to claim 8, further including an aperture member which provides fairing of beams shapes of the light beams performed coupling by the coupling lens.

10. An image forming apparatus that forms an image by fixing to a recording media a toner image formed based on a latent image obtained from information with regard to an image, comprising:
a light scanning device described in claim 1;
a photoreceptor in which a latent image is formed by the light scanning device;
an image development device that visualizes a latent image formed on a surface to be scanned of the photoreceptor; and
a transfer device that fixes to the recording media a toner image visualized by the image development device.

11. An image forming apparatus that forms a multi-color image by fixing superimposed to a recording media a toner image formed based on latent images of each color obtained from information with regard to multi-color images, comprising:
a light scanning device described in claim 1;
a plurality of photoreceptors in which latent images corresponding to each color are formed respectively by the light scanning device;
an image development device that visualizes latent images formed respectively on a surface to be scanned of the plurality of photoreceptors; and
a transfer device that fixes superimposed with the recording media toner images of each color visualized by the image development device.
